(19) United States
(12) Patent Application Publication
(10) Pub. No.: US 2020/0171444 A1
(43) Pub. Date: Jun. 4, 2020

(54) OZONE GENERATOR CONTROL SYSTEM

(71) Applicant: AbsolutAire, Inc., Kalamazoo, MI (US)

(72) Inventors: Nelson Eugene Howard, Battle Creek, MI (US); Kris R. Witteveen, Plainwell, MI (US)

(21) Appl. No.: 16/640,949

(22) PCT Filed: Aug. 24, 2018
(86) PCT No.: PCT/US2018/047895

§ 371 Date: Feb. 21, 2020

Related U.S. Application Data
(60) Provisional application No. 62/549,694, filed on Aug. 24, 2017.

(51) Int. Cl. B01F 3/04; B01F 5/04; B01F 5/10; C01B 13/11; B01F 15/00

(52) U.S. Cl. CPC B01F 3/04503; B01F 5/0413; B01F 5/106; C01B 13/11; C01B 2201/90; B01F 15/00162; B01F 15/0022; B01F 15/00285; B01F 2003/04886; B01F 15/00136

(57) ABSTRACT

The present invention disclosure relates to an ozone generator control system and related methods. An ozone generation system comprises a gaseous ozone module and an aqueous ozone module. Production of ozone and supply to points-of-use is controlled by a controller that is configured to receive signals, calculate demand, and control operational parameters of the ozone generation system.

### CROSS-REFERENCE TO RELATED APPLICATIONS

This PCT application claims priority to U.S. provisional application No. 62/549,694 filed Aug. 24, 2017, which is incorporated herein by reference.

### FIELD

The present disclosure relates to an ozone generator control system.

### BACKGROUND

This section provides background information related to the present disclosure and is not necessarily prior art.

Ozone is a powerful oxidant with many industrial and consumer applications related to oxidation. For example, ozone reacts with many organic pollutants and breaks them down into less harmful molecules through an oxidation process. Ozone is an attractive alternative to chemical disinfectant processes, such as those using chlorine, which present significant safety challenges. However, because ozone is unstable and decomposes to oxygen gas over a short period of time, it must be produced at the point-of-use by an ozone generator. Previous ozone generators have suffered from efficiency issues, safety issues, and have required manual operation.

There is a demand for ozone generators that produce both gaseous ozone and aqueous ozone (ozonated water) in a single unit, including simultaneous applications of gaseous and aqueous ozone to multiple points-of-use. Existing systems have suffered from inability to provide simultaneous independent control of aqueous and gaseous ozone. There is also demand for ozone generators that produce aqueous ozone with high concentrations of dissolved ozone and high oxidation-reduction potential (ORP). Existing systems have suffered from limitations on producing aqueous ozone at high concentrations of dissolved ozone and high ORP.

Thus, there is a need for improvement in ozone generators to provide a computer-controlled ozone generator that possesses one or more advantages such as safety, efficiency, and computer-controlled operation. There is also a need for systems that provide simultaneous independent control of gaseous and aqueous ozone to multiple point-of-use, as well as systems that are capable of producing aqueous ozone at high concentration and high ORP.

### SUMMARY

This section provides a general summary of the disclosure, and is not a comprehensive disclosure of its full scope or all of its features.

One aspect of the disclosure is an ozone generation system. The system comprises a gaseous ozone module comprising: an ozone generator unit (OGU) for producing gaseous ozone and having an OGU operation sensor and OGU operation settings; a first control valve for supplying gaseous ozone from the OGU to a gaseous point-of-use; a second control valve for supplying gaseous ozone from the OGU to an aqueous ozone module; and a gaseous ozone concentration sensor. The system also comprises an aqueous ozone module comprising: a mixer receiving water from a water supply and receiving the gaseous ozone from the gaseous ozone module via the second control valve, the mixer producing aqueous ozone; a third control valve or a first control pump for controlling a flow rate of water through the mixer; one or more pressure sensors for measuring the change in pressure across the mixer; and an aqueous ozone concentration sensor downstream of the mixer. The system also comprises a controller configured to: receive signals from the OGU operation sensor, the gaseous ozone concentration sensor; the one or more pressure sensors, and the aqueous ozone concentration sensor; calculate a gaseous ozone demand and an aqueous ozone demand based on signals from the gaseous ozone concentration sensor and the aqueous ozone concentration sensor; and control the OGU operation settings, the first control valve, the second control valve, and the third control valve or first control pump based on the signals from the OGU operation sensor, the gaseous ozone concentration sensor, the one or more pressure sensors, and the aqueous ozone concentration sensor to meet the gaseous ozone demand and the aqueous ozone demand.

In some embodiments, the OGU operation sensor comprises voltage and amperage sensors and the OGU operation settings comprise voltage and spark frequency.

In some embodiments, the controller is further configured to calculate gaseous ozone demand and aqueous ozone demand based on a gaseous ozone set point and an aqueous ozone set point.

In some embodiments, the system comprises a storage tank for receiving aqueous ozone from the mixer, wherein the aqueous ozone concentration sensor measures aqueous ozone concentration in the storage tank.

In some embodiments, the system further comprises a fourth control valve for supplying gaseous ozone from the OGU to a recirculation loop of the aqueous ozone module. In some instances, the recirculation loop comprises a second mixer receiving aqueous ozone from the storage tank and receiving gaseous ozone from the gaseous ozone module via the fourth control valve, the second mixer producing concentrated aqueous ozone, the recirculation loop returning the concentrated aqueous ozone to the storage tank; a fifth control valve or a second control pump for controlling a flow rate of aqueous ozone through the second mixer; one or more recirculation loop pressure sensors for measuring the change in pressure across the second mixer. In some instances, the controller is further configured to: receive signals from the one or more recirculation loop pressure sensors; and control the fourth control valve and the fifth control valve or second control pump to meet the aqueous ozone demand.

In some embodiments, the system further comprises an oxygen concentrator that receives air and supplies concentrated oxygen to the ozone generator unit; and an oxygen concentration sensor adjacent to an outlet of the oxygen concentrator; wherein the controller is configured to compare an oxygen concentration measured by the oxygen concentration sensor to an oxygen concentration threshold.

In some embodiments, the controller controls the OGU operation settings based on the greater of the gaseous ozone demand and aqueous ozone demand.

In some embodiments, the controller comprises a proportional-integral-derivative (PID) controller, which makes a PID calculation of gaseous ozone demand and aqueous ozone demand.

In some embodiments, the system further comprises an atmospheric ozone analyzer comprising the gaseous ozone concentration sensor, which is configured to measure a gaseous ozone concentration at the gaseous point-of-use and compare the gaseous ozone concentration to a concentration threshold, wherein the controller is configured to shut off the OGU if the gaseous ozone concentration is greater than the concentration threshold.

In some embodiments, the system further comprises one or more storage tank pressure sensor(s) on the storage tank for monitoring the volume of liquid in the storage tank, the storage tank pressure sensor(s) in communication with the controller.

In some embodiments, the controller modulates flow of liquid into the storage tank to control the volume of liquid in the storage tank.

In some embodiments, the system further comprises a pump in the recirculation loop that pumps liquid from the storage tank to the second mixer, the pump controlled by the controller.

In some embodiments, the controller modulates the third control valve or first control pump to control the flow rate of liquid through the first mixer to maintain a desired pressure drop across the first mixer.

In some embodiments, the one or more pressure sensors comprise either or both of: (i) a first pressure sensor adjacent to a liquid inlet of the mixer and a second pressure sensor adjacent to a liquid outlet of the mixer; (ii) a gas pressure sensor adjacent to a gas inlet of the mixer.

In some embodiments, the first mixer and the second mixer are injection venturis.

In some embodiments, the system further comprises a controller interface for entering set points for supply of gaseous ozone and aqueous ozone to the points-of-use.

In some embodiments, the system further comprises a second gaseous point-of-use (GPOU2) that is supplied with gaseous ozone from the OGU via a GPOU2 control valve, wherein the controller is further configured to calculate a GPOU2 demand and control the OGU operation settings and the GPOU2 control valve based on the GPOU2 demand.

In some embodiments, the system further comprises a second aqueous point-of-use (APOU2) that is supplied with aqueous ozone via a second storage tank having a second recirculation loop, wherein the controller is further configured to calculate an APOU2 demand and control the OGU operation settings and the second recirculation loop based on the APOU2 demand.

Another aspect of the disclosure is a method of generating ozone comprising: producing gaseous ozone in an ozone generator unit (OGU) having one or more OGU operation settings, and supplying the gaseous ozone to a first control valve and a second control valve; measuring one or more OGU operation parameters; supplying gaseous ozone to a gaseous point-of-use via the first control valve; measuring a gaseous ozone concentration supplied to the gaseous point-of-use; supplying gaseous ozone to an aqueous ozone module via the second control valve; mixing the gaseous ozone supplied from the second control valve with water regulated by a third control valve or first control pump in a mixer of the aqueous ozone module to produce aqueous ozone; measuring a change in pressure across the mixer using one or more pressure sensors; measuring an aqueous ozone concentration downstream of the mixer; calculating a gaseous ozone demand and an aqueous ozone demand based on the measured gaseous ozone and aqueous ozone concentrations; and controlling the one or more OGU operation settings, the first control valve, the second control valve, and the third control valve or first control pump based on the one or more OGU operation parameters, the gaseous ozone concentration, the change in pressure across the mixer, and the aqueous ozone concentration to meet the gaseous ozone demand and aqueous ozone demand.

In some embodiments, the method further comprises receiving the aqueous ozone from the mixer in a storage tank, wherein the aqueous ozone concentration is measured from aqueous ozone in the storage tank; supplying gaseous ozone from the OGU via a fourth control valve to a second mixer of a recirculation loop of the aqueous ozone module; supplying aqueous ozone from the storage tank to the second mixer via a fifth control valve or second control pump, the second mixer producing concentrated aqueous ozone; returning the concentrated aqueous ozone to the storage tank; measuring a change in pressure across the second mixer using one or more recirculation loop pressure sensors; controlling the fourth control valve and the fifth control valve or second control pump to meet the aqueous ozone demand.

Other embodiments of ozone generation methods will be apparent from the systems described herein.

The details of one or more implementations of the invention are set forth in the accompanying drawings and the description below. Other aspects, features, and advantages will be apparent from the description and drawings, and from the claims.

### DRAWINGS

The drawings described herein are for illustrative purposes only of selected configurations and are not intended to limit the scope of the present disclosure.

FIG. 1 illustrates a process diagram for a gaseous ozone module of an ozone generation system.

FIG. 2 illustrates a process diagram for an aqueous ozone module of an ozone generation system.

FIG. 3 is a reference key for the process diagrams of FIGS. 1 and 2.

FIGS. 4A-C are a flow chart of ozone generator operation and controls.

FIGS. 5A-C are a flow chart of ozone generator controls for automatic independent simultaneous control of aqueous and gaseous ozone.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element is referred to as being “on,” “engaged to,” “connected to,” “in communication with” or “upstream” or “downstream” another element, it may be directly on, engaged to, connected to, in communication with, upstream or downstream of the other element, or intervening elements may be present. In contrast, when an element is referred to as being “directly on,” “directly engaged to,” “directly connected to,” “directly in communication with,” or “directly ‘upstream’ or ‘downstream’” another element there may be no intervening elements present. Other words used to describe the relationship between elements should be interpreted in a like fashion (e.g., “between” versus “directly between,” “adjacent” versus “directly adjacent,” etc.).

As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The terms, upper, lower, above, beneath, right, left, etc. may be used herein to describe the position of various elements with relation to other elements. These terms represent the position of elements in an example configuration. However, it will be apparent to one skilled in the art that the frame assembly may be rotated in space without departing from the present disclosure and thus, these terms should not be used to limit the scope of the present disclosure.

As used herein, “gaseous ozone” refers to ozone in a gas environment, such as the output from an operating ozone generator unit that has an input of air, oxygen gas (O₂), or oxygen-concentrated air. The ozone generator unit may be a corona discharge ozone generator or a UV ozone generator. Gaseous ozone is sometimes abbreviated as “O₃” or “O₃” in the process diagrams. “Concentration” of gaseous ozone refers to the concentration of ozone (O₃) present in the gaseous ozone. The concentration of gaseous ozone may vary and may decrease over time as ozone breaks down. Concentration may be measured by a commercially available gaseous ozone monitor, such as those available from Teledyne.

As used herein, “aqueous ozone” or “ozonated water” refers to ozone mixed with water, such as the output of a mixer/reactor such as a venturi injector that mixes gaseous ozone and water (including ozonated water). Aqueous ozone is sometimes abbreviated as “H₂O₃” or “Aqueous” in the process diagrams. “Concentration” of aqueous ozone refers to the concentration of dissolved ozone (O₃) in the water. The concentration of aqueous ozone may vary and may decrease over time as ozone breaks down. Concentration may be measured by a commercially available aqueous ozone monitor, such as a Q46 monitor from Ozone Solutions, Inc.

As used herein, “control valve” refers to a valve, the flow through which is controlled by the control system and may be a solenoid valve, modulating valve, or other controller-controlled valve. A control valve may be controlled by increasing or decreasing the degree of opening (e.g., a modulating valve) or by increasing or decreasing the frequency of opening (e.g., a solenoid valve).

### II. Ozone Generation System

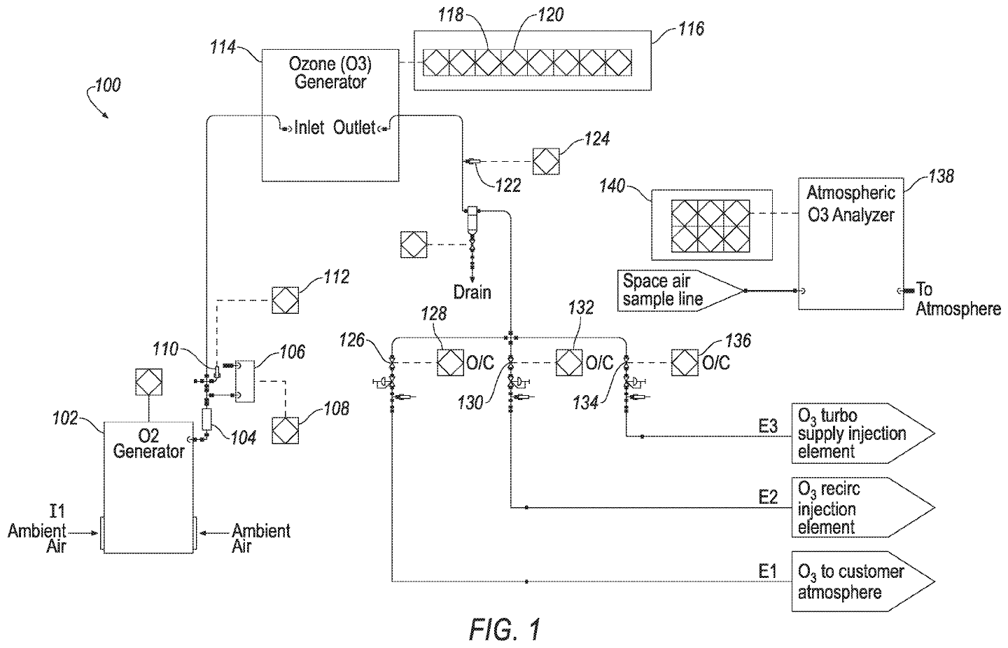

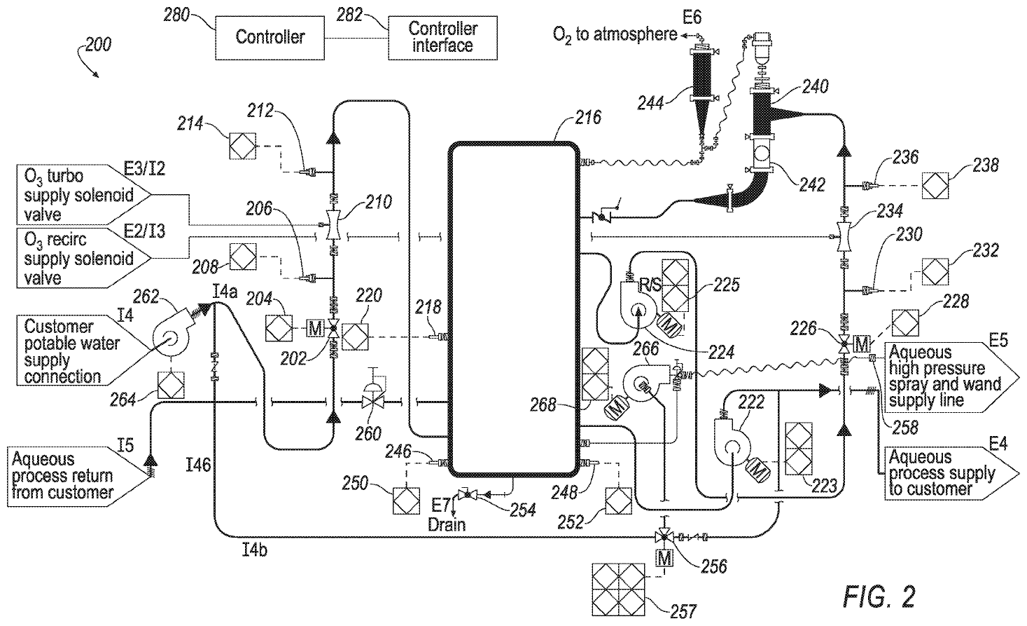

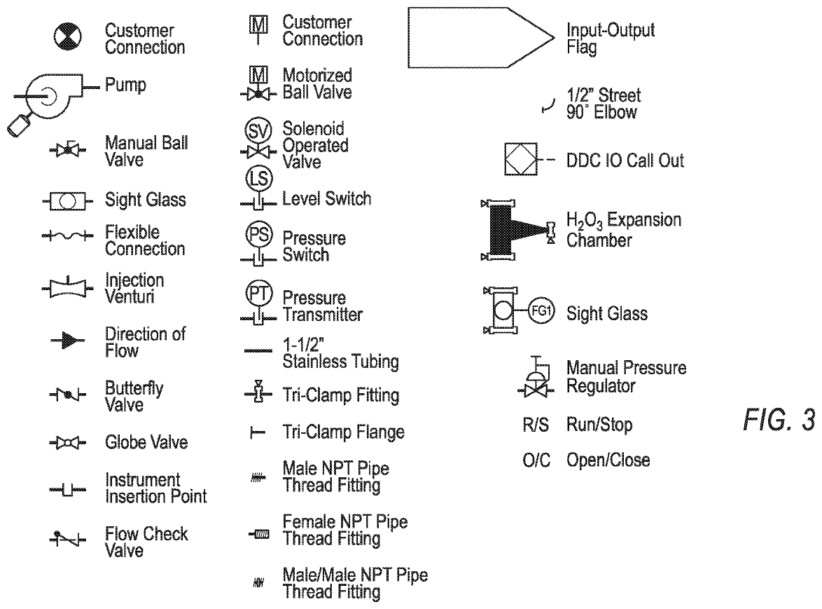

Referring to FIG. 1, a process diagram for a gaseous ozone module 100 of an ozone generation system is shown. Ambient air I1 is drawn into an oxygen (O₂) generator 102. The O₂ generator 102 increases the O₂ concentration in the air, i.e., by removing nitrogen with a filter. The O₂-concentrated air exits the generator 102 and passes through a filter 104. O₂ concentration is monitored at oxygen sensor 106 and converted to an electronic signal 108. The pressure of the O₂-concentrated air is also monitored at pressure sensor 110 and converted to an electronic signal 112. The flow proceeds to the inlet of an ozone (O₃) generator 114 that produces gaseous ozone. The term “ozone generator” is used interchangeably to refer to this discrete unit (“ozone generator unit”) for generating gaseous ozone and to refer to the overall system (“ozone generation system”) for producing gaseous and aqueous ozone. The meaning will be clear from the context. The ozone generator unit 114 may be of any known type that produces gaseous ozone from air, O₂-concentrated air, or O₂ gas. For example, the ozone generator unit 114 may be a corona discharge ozone generator. Alternatively, the ozone generator unit 114 may be an ultraviolet (UV) ozone generator. A control and monitoring unit 116 is installed on the ozone generator unit 114 and provides complete monitoring and control of ozone generator unit behavior. The complete monitoring and control via unit 116 includes monitoring of amperage and voltage (via signals 118 and 120, respectively) as well as digital monitoring whether the ozone generator unit 114 is on and whether it is outputting any alarms. The complete monitoring and control of via unit 116 also includes PDM (pulse density modulation) control of the voltage and spark frequency in the ozone generator unit 114, which modulates gaseous ozone concentration as well as digital controls for stop/start/enable of the ozone generator unit 114. Other control signals may be used for controlling the ozone generator 114, such as variable signal control or any suitable control method. The monitoring also allows controls to limit the drive to the unit 114 within recommended threshold parameters for the ozone generator unit 114. The monitoring and controls of the ozone generator unit 114 via control unit 116 are used to meet needs for gaseous ozone to atmosphere and to supply the aqueous ozone generation module 200 (see FIG. 2). Gaseous ozone exits through the outlet of the ozone generator unit 114. A pressure transmitter 122 monitors the pressure of the gaseous ozone exiting the unit and converts the pressure to an electronic signal 124. The gaseous ozone may be used as a final end product for point-of-use application. For example, the gaseous ozone may be introduced into the atmospheric air. The gaseous ozone may also be used as an intermediate product to be converted to aqueous ozone by mixing with water, as shown in FIG. 2.

In some embodiments, the system 100, 200 produces both gaseous and aqueous ozone. In this case, the gaseous ozone may be split into multiple flows for gaseous use or for further processing to aqueous ozone. Gaseous ozone control valves, which may be solenoid operated valves, control the flows of the multiple ozone streams to control the ozone levels for multiple points-of-use. For example, as shown, a first process stream controlled by a first control valve 126 is controlled by digital (or analog) signal 128 and provides gaseous ozone to a point-of-use application for gaseous ozone (e.g., introduces gaseous ozone to atmosphere) at output E1; a second process stream controlled by a second control valve 130 and signal 132 supplies gaseous ozone to an aqueous ozone generation module 200 (see FIG. 2) at output E2; and a third process stream controlled by a third control valve 134 and signal 136 also supplies gaseous ozone to the aqueous ozone generation module 200 at output E3. The second (E2) and third (E3) process streams supply gaseous ozone at different stages of the aqueous ozone generation system. Alternatively, a first controlled process stream may provide gaseous ozone to the atmosphere and a second controlled process stream may provide gaseous ozone to an aqueous ozone generation system.

In some embodiments, where gaseous ozone is introduced to atmosphere, the system also includes an atmospheric ozone analyzer 138. The atmospheric ozone analyzer 138 draws in an air sample from the atmosphere that is being supplied with gaseous ozone. The atmospheric ozone analyzer 138 monitors the concentration of gaseous ozone in the atmosphere, which is converted to signal 140. This monitoring may be used for safety and efficiency purposes. The monitoring of atmospheric ozone may be used to control the gaseous ozone control valves 126, 130, 134 and increase or decrease the supply of gaseous ozone to atmosphere and may be used to control the production of gaseous ozone at the ozone generator unit 114.

FIG. 2 shows a process diagram for an aqueous ozone generation module 200, using the gaseous ozone produced in the system of FIG. 1 as an input. Outputs E2 and E3 of the gaseous ozone module 100 provide inputs 12 and 13 for the aqueous ozone module 200. A water supply 14 is used as an additional input. In the aqueous module 200, the gaseous ozone and water are combined to form aqueous ozone, also known as ozonated water. Water from the water supply 14 flows to a controller-controlled motorized modulating valve 202 controlled by signal 204 that controls the flow of water through the valve 202. Alternatively, a solenoid valve or other control valve may be used. A pressure transmitter 206 monitors the pressure of water beyond the valve and converts to electronic signal 208. The water enters a pre-charge injection venturi 210 where gaseous ozone is mixed with the water, producing aqueous ozone. The pressure of the aqueous ozone exiting the venturi 210 is monitored by another pressure transmitter 212 downstream from the injection venturi 210. The pressure transmitter 212 converts the pressure to an electronic signal 214. Alternatively, in place of the pressure transmitters 206 and 212, a gas pressure sensor (not shown) may be installed on the gas feed to the injection venturi 210. The aqueous ozone is then supplied to an aqueous ozone storage tank 216. An aqueous ozone concentration sensor 218 monitors the concentration of aqueous ozone in the storage tank 216 and converts the concentration to an electronic signal 220. Aqueous ozone from the storage tank 216 is supplied to the point-of-use E4 (“Aqueous process supply to customer” arrow) from the storage tank 216. A controller-controlled motorized pump 222 controlled by signal 223 may be used to pump the aqueous ozone to the point-of-use application. The point-of-use application may be, for example, a spraying system. The point-of-use application may be a plumbing system that is fed by the aqueous ozone process supply E4.

In some embodiments a pump 262 may be installed at the water supply 14 to control the pressure/flow of water from the water supply to the pre-charge venturi injector 210. The pump 262 may be used in combination with a control valve to meter flow of water to the pre-charge injector 210. The pump 262 may be a controlled pump controlled by signal 264 and may be used together with or in place of the control valve 202 to regulate flow of water to the injector 210. The flow of water exiting the pump 262 may be controlled by the controller 280. The pump may be a variable frequency drive pump.

A recirculation loop may be used to control and maintain the concentration of aqueous ozone in the storage tank 216 (and thereby control the concentration of aqueous ozone to the point-of-use application). Aqueous ozone from the storage tank 216 is pumped via controller-controlled motorized pump 224 controlled by signal 225. The aqueous ozone flow is controlled by controller-controlled motorized modulating valve 226 and signal 228. Alternatively, the pump 224 may regulate to flow of liquid in the recirculation loop without use of the control valve 226. For example, the pump 224 may be a variable frequency drive pump. An aqueous ozone pressure transmitter 230 monitors the pressure of aqueous ozone beyond the valve (and converts to signal 232). An injection venturi 234 mixes the aqueous ozone with gaseous ozone to produce more concentrated aqueous ozone. The gaseous ozone supplied to the injection venturi 234 may be from a separate independently-controlled gaseous ozone supply 13 from the system 100 of FIG. 1 (via output E2). Another pressure transmitter 236 monitors the pressure of the concentrated aqueous ozone exiting the venturi 234 (and converts to signal 238). As discussed above, as an alternative to the two liquid pressure sensors 230, 236, a gas pressure sensor (now shown) can be used to measure pressure of the gaseous ozone supplied to the injection venturi 234. The concentrated aqueous ozone returns to the storage tank 216. An expansion chamber 240 may be used to release undissolved ozone gas from the concentrated aqueous ozone. The expansion chamber 240 also includes a sight glass 242 that allows for viewing of the aqueous ozone at a reduced velocity to visually observe bubbles in the aqueous ozone stream indicative of dissolved ozone. The ozone gas may be supplied to an ozone destruction unit 244 to be converted to oxygen and vented to the atmosphere as output E6. Undissolved gaseous ozone in the aqueous ozone storage tank 216 may also be supplied to the ozone destruction unit 244.

Pressure transmitters 246, 248 for volume/level control are installed on the storage tank 216. The storage tank 216 is designed to be at atmospheric pressure and the volume (i.e., level) of aqueous ozone in the storage tank 216 is therefore controlled. The pressure transmitters 246 and 248 convert to signals 250 and 252, respectively. Dual pressure transmitters provide for redundant automatic level control. The level controller controls the supply of water and gaseous ozone to the aqueous module 200 to control the flow of aqueous ozone into the storage tank 216. The level control may also control a drain valve 254 to drain aqueous ozone (E7) from the storage tank 216 to avoid pressure build-up in the storage tank 216.

A separate supply line of water I4b may be supplied to the aqueous ozone supply immediately upstream from the point-of-use. The separate supply line may be used to increase the water content and pressure of the aqueous ozone at the point-of-use application. The extra water supply I4b is controlled by a controller-controlled motorized three-way valve 256.

A high pressure spray wand 258 may also be included to provide high pressure spray of either ordinary water or ozonated water E5. A selector controlled at a controller interface 282 may be used to select between ordinary water and ozonated water. Further details of the controller interface 282 are described below. The high pressure wand 258 allows for operator-controlled spraying of ordinary water or ozonated water onto desired surfaces for cleaning. The high-pressure want may be supplied by pump 266, which may be controlled via signal 268.

Recycled aqueous ozone may be returned to the storage tank 216. The recycled aqueous ozone has lower concentration due to breakdown of the unstable ozone molecules but may be re-concentrated via the recirculation loop. The recycled aqueous ozone supply I5 may pass through a valve 260. The valve may be a manually controlled valve (as shown) or may be a controller-controlled valve. The recycled aqueous ozone supply I5 advantageously returns water that has some concentration of dissolved ozone and/or that is chemically pure from previous ozonation and is easier to re-ozonate than ordinary water.

Thus, in some embodiments, the ozone generation system 100, 200 comprises combinations of the following monitoring and control elements.

System monitoring:
Oxygen (O₂) concentration exiting O₂ generator 102 (using oxygen sensor 106, e.g., lambda sensor;
Oxygen (O₂) pressure exiting O₂ generator 102 (transmitter 110)
Gaseous ozone pressure exiting O₃ generator 114 (transmitter 122)
Atmospheric ozone analyzer 138 (gaseous ozone sensor)
Water pressure entering injection venturi 210 (transmitter 206)
Aqueous ozone pressure exiting injection venturi 210 (transmitter 212)
Aqueous ozone concentration in storage tank 216 (aqueous ozone sensor 218)
Volume of liquid in storage tank 216 (pressure transmitter(s) 246, 248 at bottom of tank 216)
Aqueous ozone pressure entering recirculation injection venturi 234 (transmitter 230)
Aqueous ozone pressure exiting recirculation injection venturi 234 (transmitter 236)

System controls:
Ozone (O₃) concentration from ozone generator unit 114 (via voltage and spark rate controlled by control unit 116)
Control valves 126, 130, 134 (e.g., solenoid valves) controlling flow of gaseous ozone to gaseous point-of-use and to venturi injectors for aqueous ozone production.
Control valve 202 (e.g., modulating valve) to liquid inlet of pre-charge injection venturi 210 (control flow rate from water supply to pre-charge venturi)
Control valve 226 (e.g., modulating valve) to liquid inlet of recirculation injection venturi 234 (control flow rate from storage tank to recirculation venturi)
Pump 224 for recirculation loop (control flow rate from storage tank to recirculation loop)
Pump 262 for pre-charge section (control flow rate from water supply to pre-charge injector), optionally with control valve
Drain valve 254 for storage tank
Control valve 256 for high pressure water supply at point-of-use

### III. Ozone Control System

Another aspect of the invention is an ozone generation control system. The control system comprises a controller 280 (or multiple controllers) in electronic communication with the monitors (pressure transmitters (110, 122, 206, 212, 230, 236, 246, 248) concentration monitors (106, 138, 218) etc.) and controlled equipment (control valves (126, 130, 134, 202, 226, 256 254), pumps (224, 262), ozone generator control unit 116, etc.) discussed above. The controller 280 may be a programmable logic controller (PLC). The controller 280 may have an interface 282 (i.e., “controller interface”) whereby set points and thresholds may be entered and adjusted. The interface 282 may also provide a display for visual monitoring of system parameters. In some examples, the controller interface 282 is a graphical user interface configured to receive user inputs to program and/or instruct the controller 280 to perform one or more operations. The controller interface 282 may include a display which may execute a touch screen for receiving the user inputs and/or the controller interface 282 may include one or more buttons for receiving the user inputs.

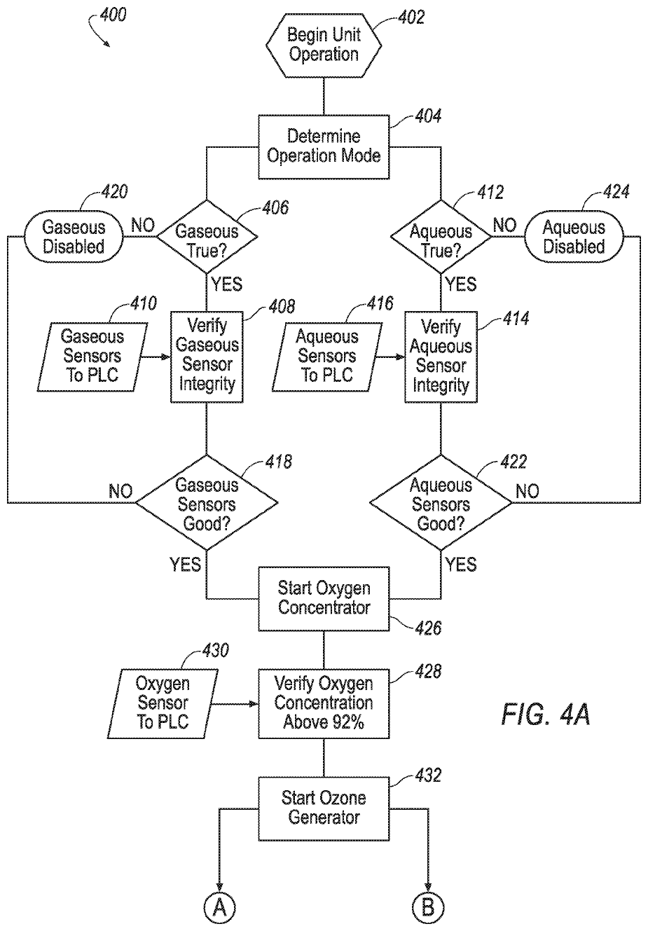

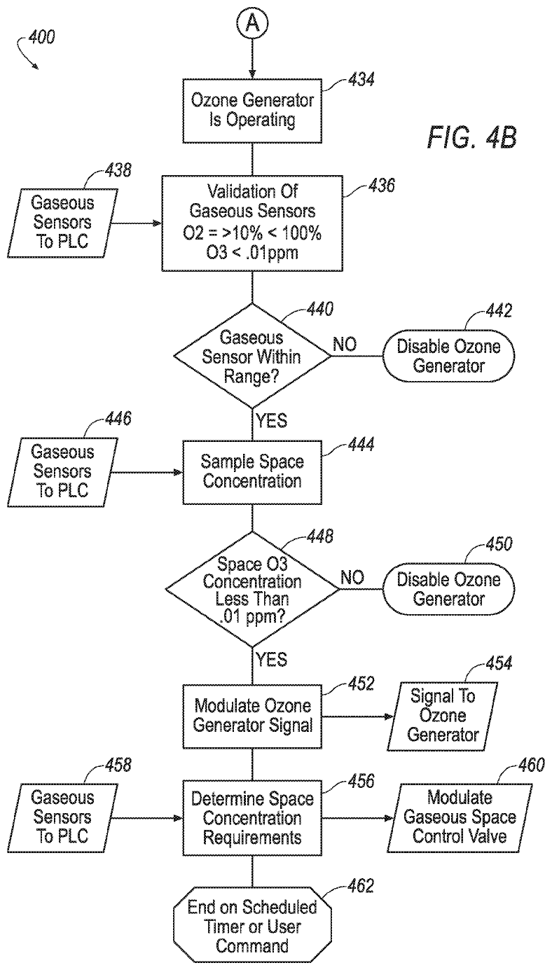

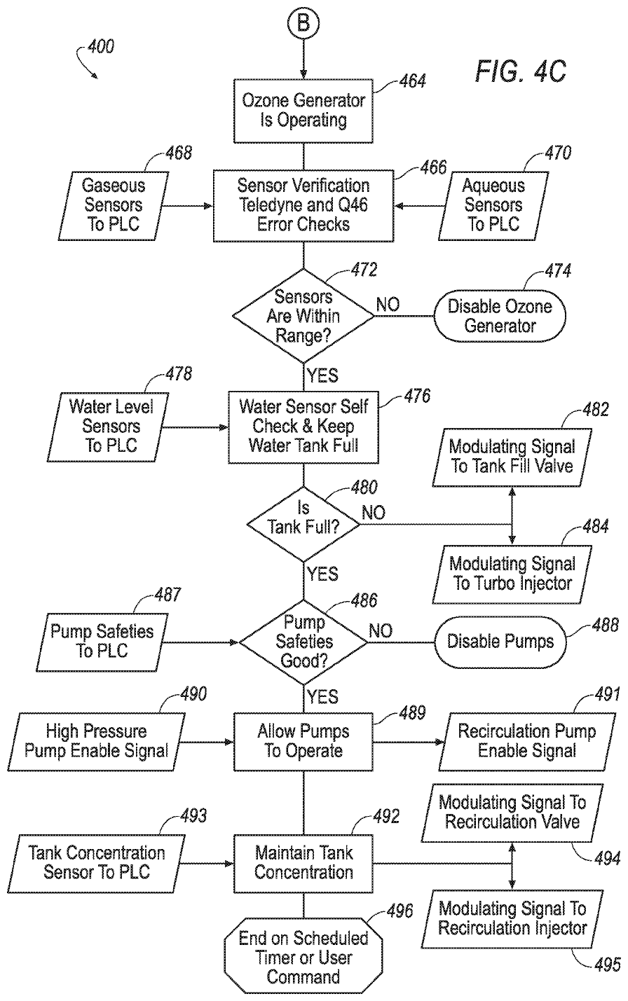

Referring to FIGS. 4A, 4B and 4C, a flow chart 400 for the ozone generation control system is provided. The flow chart starts by begin unit operation 402 and determine operation mode 404. The operation mode of the ozone generation control system may include a gaseous mode, an aqueous mode, or both the gaseous and aqueous modes. In the gaseous mode (also referred to as “gaseous operation mode”), the ozone generation system supplies gaseous ozone to the atmosphere (i.e., environment or space) at the point-of-use. In the aqueous mode (also referred to as “aqueous operation mode”), the ozone generation system supplies aqueous ozone to a point-of-use, e.g., by pipe flow or spraying. Using the controller interface 282 (FIG. 2), the user may select the gaseous mode, the aqueous mode, or both the gaseous and aqueous modes. If the gaseous operation mode is activated/selected (i.e., 406 is “YES”), the control system verifies gaseous sensor integrity 408 by sending a signal 410 from the gaseous sensors to the PLC (programmable logic controller) 280. The gaseous sensors include the sensors in FIG. 1, the process diagram for gaseous ozone production. Likewise, if the aqueous operation mode is activated/selected (i.e., 412 is “YES”), the control system verifies aqueous sensor integrity 414 by sending a signal 416 from the aqueous sensors to the PLC 280. The aqueous sensors include the sensors in both FIG. 1 and FIG. 2 (gaseous and aqueous process diagrams), excluding the atmospheric ozone analyzer sensor 138. If the gaseous sensors are not operating properly, the gaseous system is disabled. If the aqueous sensors are not operating properly (i.e., 422 is “NO”), the aqueous system is disabled at 424. If sensors are operating properly, i.e., 418 and 422 are both “YES”, then the flow chart 400 proceeds and starts the oxygen concentrator at 426. The oxygen concentrator determines whether oxygen concentration is above a threshold (e.g., 92%) at block 428 and sends a signal 430 to the PLC 280 when the oxygen concentrator verifies that the oxygen concentration is above the threshold. When the oxygen concentration satisfies the threshold, the ozone generator unit is started at 432. The flow chart then proceeds via path A to FIG. 4B for the gaseous operation mode and via path B to FIG. 4C for the aqueous operation mode.

Referring to FIG. 4B, for the gaseous operation mode, with the ozone generator unit operating at block 434 from FIG. 4A, the controller 280 next validates the gaseous sensors at 436. The gaseous sensors monitor oxygen concentration and ozone concentration at 438 and the controller 280 determines whether the concentrations are within defined tolerances at block 440. For example, the tolerances may be greater than 10% and less than 100% for oxygen concentration and less than 0.01 ppm for ozone concentration. Oxygen concentration is measured at the output of the oxygen (O₂) generator 102 and ozone concentration is measured at the atmospheric ozone analyzer 138. When the gaseous sensors are not within the tolerance ranges (i.e., 440 is “NO”), the ozone generator unit is disabled at block 442. When gaseous sensors are within ranges (i.e., 440 is “YES”), the flow chart 400 proceeds to monitoring the sample space concentration (i.e., atmospheric concentration) at block 444. The space concentration also has defined tolerances. For example, the tolerances may be an ozone concentration of less than 0.01 ppm. When the space concentration is outside the tolerances (i.e., 448 is “NO”), then the ozone generator unit is disabled at block 450. When the space concentration is within the tolerances (i.e., 448 is “YES”), then the flow chart 400 proceeds to modulating the ozone generator unit signal at block 452. The ozone space concentration is continuously monitored during operation to ensure that atmospheric ozone concentration does not reach unsafe levels. At the modulate ozone generator signal block 452, the ozone generator unit parameters (i.e., voltage and spark frequency) can be adjusted via signal block 454 to provide a controlled concentration of gaseous ozone for the point-of-use and downstream functions (i.e., venturi injectors). Voltage and spark frequency control may be used to control a corona discharge ozone generator unit. The control system can also be adapted to control other types of ozone generators, e.g., a UV ozone generator. The control system would be adapted to control the operating parameters of the UV ozone generator or other type of ozone generator to achieve the ozone concentration demand calculated by the control system. Here, the PLC sends a signal at 454 to control/adjust the ozone generator unit parameters. The gaseous sensors continue to monitor concentration and pressure and signal the PLC 280. Space (atmospheric) concentration requirements may be inputted at 456. The gaseous ozone control valve that controls supply of gaseous ozone to the space/atmosphere is modulated via 460 based upon the signal 458 from the gaseous sensors and the space concentration requirements at 456. For example, when the atmospheric ozone analyzer 138 senses that atmospheric ozone concentration is below the set point, the control valve 126 supplying gaseous ozone to atmosphere can be opened (or opened more frequently) to increase flow of gaseous ozone to atmosphere. As discussed in more detail below, both the concentration of ozone produced and the flow rate through each of the gaseous ozone control valves can be adjusted in cooperation by the PLC 280 to meet the supply needs for gaseous and aqueous ozone. The operation ends on scheduled timer or user command at 462.

Referring to FIG. 4C, for the aqueous operation mode, with the ozone generator unit 114 operating from FIG. 4A at 464, the controller 280 next verifies operation of the gaseous and aqueous sensors at block 466 via blocks 468 and 470. When sensors are not within defined tolerances (i.e., 472 is “NO”), the ozone generator unit is disabled at 474. When sensors are within the tolerances (i.e., 472 is “YES”), a tank level (labelled as “water sensor”/“water level” but referring to the level (i.e., height or volume) of ozonated water in the storage tank) sensor self-check is performed at block 476 and the storage tank level sensors (labelled “water level sensors”) signal the PLC 280 at block 478 with the objective to keep the storage tank at a desired volume. When the tank is less than the desired volume (i.e., 480 is “NO”), modulating signals at 482 and 484 are sent to the tank fill control valve 202 and the supply valve 134 to the pre-charge (“turbo”) injector 210 to increase the supply of aqueous ozone to the storage tank 216. The process controls strike a balance between meeting volume demand to the storage tank 216 and maintaining optimized pressure drop across the injection venturi 210. Tank volume control is tied to a first control loop that controls supply of gaseous ozone and process water to the storage tank 216 through the pre-charge injection venturi 210. This first control loop for tank volume control is separate from the control of supply through the recirculation loop. The flow chart 400 next performs a pump safety check at 486 via block 487 and disables pumps at 488 when a safety problem is detected (i.e., low liquid supply to pumps that would damage the pumps). When no safety problems are detected (i.e., 486 is “YES”), the control system allows the pumps to operate at 489, activating the recirculation pump at 491 and the high pressure pump at 490. Finally, the controller 280 maintains the aqueous ozone concentration in the tank at 492 using a recirculation control loop. The tank (aqueous ozone) concentration sensor 218 sends a signal 220 to the PLC 280 at block 493. The PLC 280 modulates the signal to the recirculation control valve 226 at block 494 and the gaseous ozone control valve 130 at block 495 that supplies the recirculation injector 234 based on the signal received from the tank concentration sensor at 493. Tank concentration control is tied to a second control loop that controls supply of gaseous ozone and aqueous ozone from the storage tank 216 through the recirculation injection venturi 234. This second control loop for tank concentration (of aqueous ozone) is separate from the control of supply through the pre-charge section. The operation ends on scheduled timer or user command at 496.

The ozone generation control system is sequenced to operate according to a defined sequence, for example, as illustrated in the flow charts of FIGS. 4A, 4B and 4C. The system can be activated by a single on command and input of desired set-point levels (i.e., for point-of-use outputs). The system can be scheduled to run automatically at certain times of day, to cycle on and off, and to run at different set-point levels at different times, and the like.

### A) Fully Automated Tank Level Control Using Pressure Transmitters and Controller-Controlled Valves

In some embodiments, the control system comprises fully automated tank level control using one or more pressure transmitters and controller-controlled valves. The one or more pressure transmitters are installed at or near the bottom of the storage tank that holds the aqueous ozone before supply to the point-of-use. The one or more pressure transmitters continuously monitor the pressure caused by head pressure in the tank, i.e., caused by the depth of the liquid in the tank. This pressure reading is correlated to the volume or level of liquid in the storage tank and converted to an electronic signal and communicated to the control system. Two (or more) pressure transmitters may be used for redundant monitoring of head pressure. In this case, if one transmitter is recognized as unreliable, the controller may continue to operate using the other sensor while showing a sensor alarm. If both sensors are operating properly, then an average reading may be taken to provide a more accurate reading of tank level. The tank level control loop will recognize if tank level is too high or too low based on the pressure reading from the one or more pressure transmitters. The flow into the tank is then modulated by the controller to return the tank to its desired level. For example, if pressure falls below a set threshold indicating that tank level is low, pre-charged aqueous ozone may be added to the tank by opening controller-controlled valves. The threshold value may be values set by a user in the controller interface or defined in the interface. Additionally, if pressure falls below a second threshold indicating tank volume is dangerously low, risking damage to the pumps, then the pumps may be disabled by the controller until tank volume returns to a safe level.

### B) Pressure-Based Control of Controller-Controlled Valves to Optimize Injection of Ozone into Water Stream

Embodiments of the invention include one or more injection venturis (or “venturi injectors”) for injecting gaseous ozone into a stream of water or injecting gaseous ozone into a stream of aqueous ozone to increase the concentration of the aqueous ozone. Pressure transmitters may be installed at or near the liquid inlet and liquid outlet of the venturi. Alternatively, a pressure transmitter may be installed on near the gas inlet of the venturi. The pressure transmitters are used to monitor the pressure drop across the injection venturi. The pressure transmitters communicate with the controller such that the pressure drop across the venturi is determined. The controller modulates the system to maintain a pressure drop across the venturi injector within a desired range, e.g., 10 to 15 psi. The desired range may be an optimum range for absorption of ozone into the water. The controller controls the pressure drop by modulating the liquid flow rate through the venturi injector using a variable frequency drive (VFD) (controlling pump speed) or by modulating a control valve that supplies flow of the liquid (water or aqueous ozone) to the venturi.

### C) Integrated Sensor Readings for Ozone Concentration into the Modulating Control of Ozone Generation

Embodiments of the invention also include ozone concentration monitoring and modulation of ozone supply by flow and concentration. Gaseous ozone is delivered to the venturi injectors and/or the gaseous point-of-use by varying combinations of flow rate and ozone concentration. The controller continuously monitors ozone concentration sensors and compares those sensor readings with set points that are entered or reside in the controller interface. If ozone concentration is low, the controller will increase ozone concentration (by increasing ozone production at the ozone generator unit) or increase flow rate of the gaseous ozone streams to the required point. Concentration monitoring may include atmospheric monitoring of ozone concentration for control of gaseous ozone supply or monitoring of dissolved ozone concentration in the storage tank for control of aqueous ozone supply, or both.

When the controller determines that the concentration of ozone must be increased (rather than that the flow rate of gaseous ozone must be increased), then the modulation demand to the ozone generator unit is increased. This increased modulation signal causes voltage and spark frequency in the generator to increase which in turn increases the concentration of the ozone produced. Likewise, when the controller determines that concentration of ozone must be decreased, then the modulating demand signal to the ozone generator unit is decreased, lowering concentration of ozone produced.

When the controller determines that the flow of ozone must be increased (rather than concentration), then the gaseous ozone control valves (which meter the supply of gaseous ozone to the venturi injectors and the gaseous point-of-use application) are modulated to increase supply. The gaseous ozone control valves open more or open more frequently to increase the gaseous ozone flow rate through the respective control valves. Likewise, when the controller determines that the flow of ozone must be decreased, the demand signal to the gaseous ozone control valves is decreased, reducing the flow.

The control system continuously monitors the aqueous ozone concentration, gaseous ozone concentration, and other sensors and determines the point-of-use with the greatest demand for gaseous ozone production. The point-of-use with the greatest demand is selected and the greatest demand is used to modulate ozone generation, i.e., concentration exiting the ozone generator unit. The control system continuously modulates the gaseous ozone control valves to each point-of-use or downstream operation to deliver a controlled flow of the gaseous ozone exiting the ozone generator unit (which is itself continuously modulated) to independently meet the demand for each point-of-use or downstream operation.

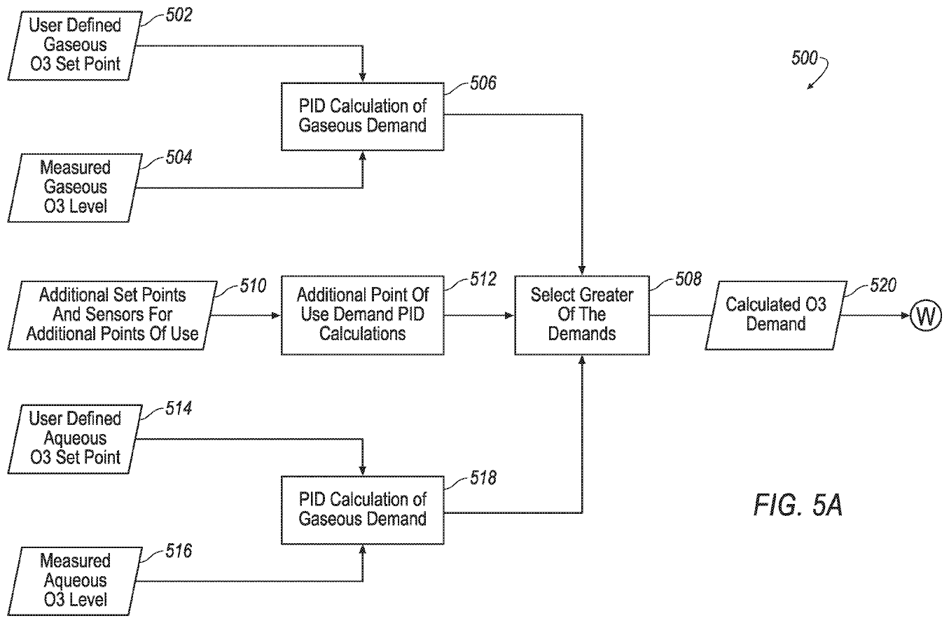

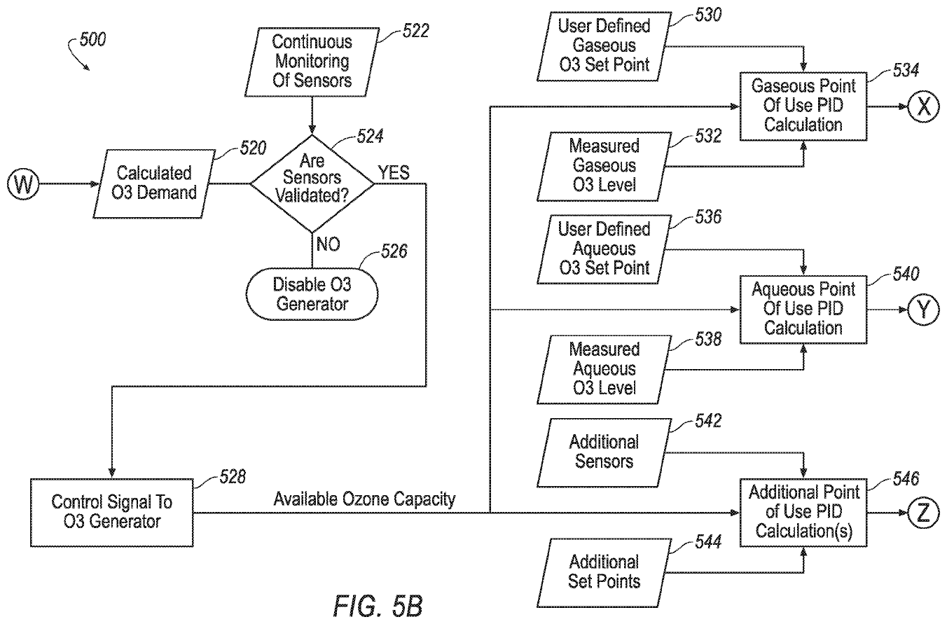

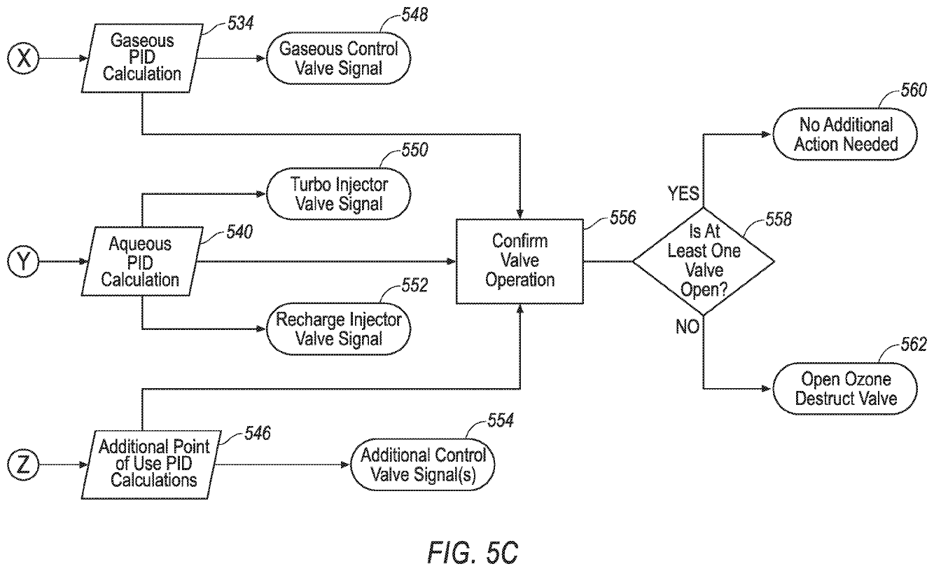

Referring to FIGS. 5A, 5B and 5C, a flow chart 500 for automatic independent simultaneous control of aqueous and gaseous ozone is provided. Referring to FIG. 5A, user defined set points for gaseous and aqueous ozone are entered at 502, i.e., via the controller interface 282. Additional set points for additional points-of-use may also be entered at block 510, 514. The control system compares the set points to the measured gaseous and aqueous ozone levels (concentrations) from 504 and 516. The controller of the control system performs a proportional-integral-derivative (PID) calculation for gaseous demand for each point-of-use (or downstream operation) at block 506, 512 and 518. The control system then selects the greater of each of the calculated demands at block 508 and uses this as the calculated ozone demand at block 520 for the ozone generator unit.

Referring to FIG. 5B, the sensors, which are already being continuously monitored at 522, are validated at block 524. If the sensors are not signaling properly (i.e., 524 is “NO”), the ozone generator unit is disabled at 526. If the sensors are validated (i.e., 524 is “YES”), a control signal is sent (at block 528) to the ozone generator unit 114 and the ozone generation system begins operation. With the ozone generation system operating, the control system continues to monitor gaseous ozone levels at 532, aqueous ozone levels at 538 and additional sensors at 542 and compare those levels to the user defined set points 530, 536, 544. The controller continues to make PID calculations at 534, 540, 546 for each point-of-use (or downstream operation).

Referring to FIG. 5C, the gaseous PID calculation 534, aqueous PID calculation 540 and any additional point-of-use PID calculations 546 are used to control the gaseous ozone control valves at 548, 550, 552, 554 to the points-of-use or downstream operations. The gaseous PID calculation is used to control the control valve 126 that meters flow to the gaseous ozone to customer atmosphere point-of-use. The aqueous PID calculation is used to control the control valves 130, 134 that meter flow to the pre-charge (“turbo”) injector and the recirculation injector. Additional point-of-use PID calculations 546 are used to control additional valves at 554. The controller confirms valve operation at 556 by determining whether or not at least one valve is open at 558. When at least one valve is open (i.e., 558 is “YES”), the system continues operation at 560. When the controller determines that no valves are open (i.e., 558 is “NO”), the controller 280 opens an ozone destruction control valve at 562 to prevent stoppage of flow to the oxygen concentrator 102 and ozone generator unit 114 while not allowing manufactured ozone to be released into the atmosphere.

### D) Controller Interface

Embodiments of the invention also include a controller interface 282. The interface 282 may include a display that allows an individual to enter set points and read the status of system parameters. The display may be a touch screen display. The interface 282, e.g., graphical user interface (GUI), allows an individual to choose between gaseous ozone output, aqueous ozone output, or both. The interface 282 also allows an individual to select the desired ozone concentration and flow rate for the gaseous and aqueous ozone outputs to the point-of-use application (within system constraints). In addition or in lieu of the touch screen display, the interface 282 may include one or more buttons configured to receive user inputs for entering the set points.

### E) Process Loop Controlled Ozone Delivery to Multiple Sources

Using the ozone generation systems and control systems described herein, an ozone generator may supply gaseous ozone to atmosphere and aqueous ozone to point-of-use plumbing systems or as a spray at the point-of-use. Additionally, systems with delivery of gaseous ozone to multiple atmospheres (e.g., different rooms) and aqueous ozone to multiple points-of-use are envisioned. Additional control valves and atmospheric analyzers would be used for multiple gaseous points-of-use. Multiple points-of-use for aqueous ozone with independent ozone concentration control would require, for example, a separate storage tank and recirculation loop with separate injection venturi with independently modulated gaseous ozone supply to the venturi. Multiple PLCs may also be employed in a networked configuration to provide individual control at multiple points-of-use while sending demand level and sensor data to a central controller of the ozone generation control system.

### IV. Ozone Generation Methods

Another aspect of the invention is a method of producing ozone comprising controlling ozone production. Another aspect of the invention is a method of controlling ozone production. The method of producing ozone may include producing gaseous ozone, aqueous ozone, or both. Methods of generating ozone and/or controlling ozone production may be practiced in accordance with the ozone generation system and control system described above and will be understood by a person of ordinary skill in the art.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An ozone generation system comprising:
a gaseous ozone module comprising:
an ozone generator unit (OGU) for producing gaseous ozone and having an OGU operation sensor and OGU operation settings;
a first control valve for supplying gaseous ozone from the OGU to a gaseous point-of-use;
a second control valve for supplying gaseous ozone from the OGU to an aqueous ozone module; and
a gaseous ozone concentration sensor;
an aqueous ozone module comprising:
a mixer receiving water from a water supply and receiving the gaseous ozone from the gaseous ozone module via the second control valve, the mixer producing aqueous ozone;
a third control valve or a first control pump for controlling a flow rate of water through the mixer;
one or more pressure sensors for measuring the change in pressure across the mixer; and
an aqueous ozone concentration sensor downstream of the mixer; and
a controller configured to:
receive signals from the OGU operation sensor, the gaseous ozone concentration sensor; the one or more pressure sensors, and the aqueous ozone concentration sensor;
calculate a gaseous ozone demand and an aqueous ozone demand based on signals from the gaseous ozone concentration sensor and the aqueous ozone concentration sensor; and
control the OGU operation settings, the first control valve, the second control valve, and the third control valve or first control pump based on the signals from the OGU operation sensor, the gaseous ozone concentration sensor, the one or more pressure sensors, and the aqueous ozone concentration sensor to meet the gaseous ozone demand and the aqueous ozone demand.

2. The system of claim 1, wherein the OGU operation sensor comprises voltage and amperage sensors and the OGU operation settings comprise voltage and spark frequency.

3. The system of claim 1, wherein the controller is further configured to calculate gaseous ozone demand and aqueous ozone demand based on a gaseous ozone set point and an aqueous ozone set point.

4. The system of claim 1, further comprising a storage tank for receiving aqueous ozone from the mixer, wherein the aqueous ozone concentration sensor measures aqueous ozone concentration in the storage tank.

5. The system of claim 4, further comprising:
a fourth control valve for supplying gaseous ozone from the OGU to a recirculation loop of the aqueous ozone module;
the recirculation loop comprising:
a second mixer receiving aqueous ozone from the storage tank and receiving gaseous ozone from the gaseous ozone module via the fourth control valve, the second mixer producing concentrated aqueous ozone, the recirculation loop returning the concentrated aqueous ozone to the storage tank;
a fifth control valve or a second control pump for controlling a flow rate of aqueous ozone through the second mixer;
one or more recirculation loop pressure sensors for measuring the change in pressure across the second mixer;
wherein the controller is further configured to:
receive signals from the one or more recirculation loop pressure sensors; and
control the fourth control valve and the fifth control valve or second control pump to meet the aqueous ozone demand.

6. The system of claim 1, further comprising:
an oxygen concentrator that receives air and supplies concentrated oxygen to the ozone generator unit; and
an oxygen concentration sensor adjacent to an outlet of the oxygen concentrator;
wherein the controller is configured to compare an oxygen concentration measured by the oxygen concentration sensor to an oxygen concentration threshold.

7. The system of claim 1, wherein the controller controls the OGU operation settings based on the greater of the gaseous ozone demand and aqueous ozone demand.

8. The system of claim 1, wherein the controller comprises a proportional-integral-derivative (PID) controller, which makes a PID calculation of gaseous ozone demand and aqueous ozone demand.

9. The system of claim 1, further comprising an atmospheric ozone analyzer comprising the gaseous ozone concentration sensor, which is configured to measure a gaseous ozone concentration at the gaseous point-of-use and compare the gaseous ozone concentration to a concentration threshold, wherein the controller is configured to shut off the OGU if the gaseous ozone concentration is greater than the concentration threshold.

10. The system of claim 4, further comprising one or more storage tank pressure sensor(s) on the storage tank for monitoring the volume of liquid in the storage tank, the storage tank pressure sensor(s) in communication with the controller.

11. The system of claim 10, wherein the controller modulates flow of liquid into the storage tank to control the volume of liquid in the storage tank.

12. The system of claim 5, further comprising a pump in the recirculation loop that pumps liquid from the storage tank to the second mixer, the pump controlled by the controller.

13. The system of claim 1, wherein the controller modulates the third control valve or first control pump to control the flow rate of liquid through the first mixer to maintain a desired pressure drop across the first mixer.

14. The system of claim 1, wherein the one or more pressure sensors comprise either or both of: (i) a first pressure sensor adjacent to a liquid inlet of the mixer and a second pressure sensor adjacent to a liquid outlet of the mixer; (ii) a gas pressure sensor adjacent to a gas inlet of the mixer.

15. The system of claim 5, wherein the first mixer and the second mixer are injection venturis.

16. The system of claim 1, further comprising a controller interface for entering set points for supply of gaseous ozone and aqueous ozone to the points-of-use.

17. The system of claim 1, further comprising a second gaseous point-of-use (GPOU2) that is supplied with gaseous ozone from the OGU via a GPOU2 control valve, wherein the controller is further configured to calculate a GPOU2 demand and control the OGU operation settings and the GPOU2 control valve based on the GPOU2 demand.

18. The system of claim 5, further comprising a second aqueous point-of-use (APOU2) that is supplied with aqueous ozone via a second storage tank having a second recirculation loop, wherein the controller is further configured to calculate an APOU2 demand and control the OGU operation settings and the second recirculation loop based on the APOU2 demand.

19. A method of generating ozone comprising:
producing gaseous ozone in an ozone generator unit (OGU) having one or more OGU operation settings, and supplying the gaseous ozone to a first control valve and a second control valve;
measuring one or more OGU operation parameters;
supplying gaseous ozone to a gaseous point-of-use via the first control valve;
measuring a gaseous ozone concentration supplied to the gaseous point-of-use;
supplying gaseous ozone to an aqueous ozone module via the second control valve;
mixing the gaseous ozone supplied from the second control valve with water regulated by a third control valve or first control pump in a mixer of the aqueous ozone module to produce aqueous ozone;
measuring a change in pressure across the mixer using one or more pressure sensors;
measuring an aqueous ozone concentration downstream of the mixer;
calculating a gaseous ozone demand and an aqueous ozone demand based on the measured gaseous ozone and aqueous ozone concentrations; and
controlling the one or more OGU operation settings, the first control valve, the second control valve, and the third control valve or first control pump based on the one or more OGU operation parameters, the gaseous ozone concentration, the change in pressure across the mixer, and the aqueous ozone concentration to meet the gaseous ozone demand and aqueous ozone demand.

20. The method of claim 19, further comprising:
receiving the aqueous ozone from the mixer in a storage tank, wherein the aqueous ozone concentration is measured from aqueous ozone in the storage tank;
supplying gaseous ozone from the OGU via a fourth control valve to a second mixer of a recirculation loop of the aqueous ozone module;
supplying aqueous ozone from the storage tank to the second mixer via a fifth control valve or second control pump, the second mixer producing concentrated aqueous ozone;
returning the concentrated aqueous ozone to the storage tank;
measuring a change in pressure across the second mixer using one or more recirculation loop pressure sensors;
controlling the fourth control valve and the fifth control valve or second control pump to meet the aqueous ozone demand.
